(19) United States
(12) Patent Application Publication
(10) Pub. No.: US 2021/0385428 A1
(43) Pub. Date: Dec. 9, 2021

(54) SYSTEM AND METHOD FOR IDENTIFYING A RELATIVE POSITION AND DIRECTION OF A CAMERA RELATIVE TO AN OBJECT

(71) Applicant: ASSAF ASHEROV, TEL AVIV (IL)

(72) Inventor: ASSAF ASHEROV, TEL AVIV (IL)

(21) Appl. No.: 17/292,730

(22) PCT Filed: Jan. 27, 2021
(86) PCT No.: PCT/IL2021/050091

§ 371 Date: May 11, 2021

(30) Foreign Application Priority Data
Feb. 3, 2020 (IL) 272435

(51) Int. Cl. H04N 13/275; H04N 13/282; G06T 7/80; G06T 15/20

(52) U.S. Cl. CPC H04N 13/275; H04N 13/282; G06T 2207/30244; G06T 15/205; G06T 2215/16; G06T 7/85

(57) ABSTRACT

The subject matter discloses a method, comprising obtaining a three-dimensional model of an area of interest comprising distances between points in the area of interest, capturing images of the area of interest; and computing a relative location and direction of the camera relative to a reference object based on the three-dimensional model.

### FIELD OF THE INVENTION

The present invention relates to identifying a relative position and direction of a camera relative to an object.

### BACKGROUND OF THE INVENTION

Computer vision is a rapidly growing technology field. Billions of images are captured on a daily basis, either by private users, by cameras installed on public places, such as surveillance cameras, by cameras installed on devices such as vehicles and drones and the like. There are many usages for the captured images, from documentation, leisure, to collecting business-oriented information such as the amount of people in a business place during a business day.

Some of the usages of computer vision requires to calculate a relative position between the camera and an object in the captured image. This may be used to determine, or at least estimate, the object's location in an area of interest captured by the camera. Another usage of computer vision may be to embed, for example in augmented reality techniques, an object in a real area of interest captured by the camera. The object's proper orientation in the area of interest may be determined by the orientation of the camera in the area of interest. For example, in case the camera is located 20 meters higher than the ground, a vehicle on the road may look smaller than in case the camera is located 2.5 meters higher than the ground. Computer vision algorithms that use the captured images fail to accurately compute the camera's three-dimensional location (defined by the distance in the X, Y and Z axis) relative to a predefined object in the image, as well as the camera's three-dimensional direction (defined by the camera's direction in the X, Y and Z axis) relative to the predefined object in the image

### SUMMARY OF THE INVENTION

It is an object of the subject matter to disclose a method, comprising obtaining a three-dimensional model of an area of interest comprising distances between points in the area of interest, capturing images of the area of interest, computing a relative location and direction of the camera relative to a reference object based on the three-dimensional model.

In some cases, the method further comprising placing a virtual three-dimensional object into the captured image according to the computed relative location and direction of the camera.

In some cases, the method is performed on a personal electronic device comprising a camera used to the capturing images of the area of interest.

In some cases, the method further comprising extracting edges of objects in the area of interest from the image captured by the camera and performing extrapolation between the extracted edges and the three-dimensional model. In some cases, the method further comprising collecting motion-based measurements of the device used to capture the image of the area of interest. In some cases, the method further comprising narrowing search in the three-dimensional model of an area of interest based of the motion-based measurements.

In some cases, the 3D model comprises a list of points, and distances between the points in the area of interest, wherein the points are defined by their absolute locations, wherein computing the relative location and direction of the camera relative to the predefined point in the area of interest based on the distances between points in the three-dimensional model.

In some cases, the method further comprising matching between two-dimensional (2D) points in the image captured by the camera to two-dimensional (3D) points in the 3D model.

In some cases, the method further comprising generating a cost function which can be minimized in order to get the most likely camera's position and orientation. In some cases, the relative location and direction are defined in 6 values, wherein 3 values define the relative location in each dimension and 3 values define the relative direction in each dimension.

In some cases, the 3D model is included in a Geographic Information System (GIS).

In some cases, the method further comprising placing a virtual object into the captured image based on the computed relative location and direction of the camera. In some cases, the virtual object comprises object information that enables to display the object from multiple directions. In some cases, the method further comprising reformatting the virtual object according to the computed location and direction.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method for computing a camera's distance and direction relative to a reference object with a setup phase, according to exemplary embodiments of the present invention;

FIG. 2 shows a method for computing a camera's distance and direction relative to a reference object after capturing an image of the area of interest, according to exemplary embodiments of the present invention;

FIGS. 3A-3B show optional systems for computing a camera's distance and direction relative to a reference object, according to exemplary embodiments of the present invention; and,

FIG. 4 schematically shows a camera and the area of interest captured by the camera, according to exemplary embodiments of the present invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

The subject matter discloses a system and method for computing a camera's three-dimensional relative position and direction from a reference object in an area of interest. The reference object may be a three-dimensional location in a three-dimensional model of the area of interest. In some other cases, the system obtains the relative distance and direction between the reference object and the area of interest. The reference object is also defined by a three-dimensional direction, and the output of the method may be the direction of the camera relative to the reference object's direction. The image may be a still image, part of a video stream or a video file. The camera may be a standalone camera, or embedded in a personal electronic device such as a cellular phone, tablet, laptop and the like. The camera's relative position may be defined by a difference in the locations in each axis relative to the reference object. That is, the camera's location relative to the reference object may be (5.5, 25, −22), as 5.5 defines the location difference in the X axis, 25 defines the location difference in the Y axis and −22 defines the location difference in the Z axis. The use of negative values may be defined, for example, in case the camera is lower or higher than the reference object. The camera's direction relative to the reference object may be defined by the angle between the camera and the reference object, said angle is defined in three dimensions. The camera's direction relative to the reference object may be defined as (45.5, 125, 30), as 45.5 defines the angle in the X axis, 125 defines the angle in the Y axis and 30 defines the angle difference in the Z axis.

The method of the subject matter comprises utilizing the three-dimensional model (also defined as a 3D model) of the area of interest in order to compute the camera's three-dimensional relative position and direction from a reference object. The 3D model comprises points in the area of interest and the distances between these points. For example, the points may be edges of buildings, treetops, corners of rectangular yards and the like. The 3D model may be extracted from a database of geographic information, such as a database owned by cities. The 3D model, or portions thereof, may result from measurements performed by professional measurers or performed by a dedicated tool, such as a robot, drone and the like. The distances between points in the 3D model are used to compute the camera's direction and location relative to the reference point, for example by modeling the points from the 3D model into images captured by the camera, as elaborated below. The method may also disclose calibrating the camera, and performing an interpolation process on the captured image in order to locate the points from the 3D model on the captured images.

The method of the subject matter may be implemented on the personal electronic device that comprises the camera, or in a server communicating with a device that receives the images captured by the camera or offline processing on another device such as a laptop or desktop computer. That is, the computation may be performed by a processing module of the personal electronic device and the computation algorithms and set of rules may be stored in the personal electronic device. In some other cases, the computation may be performed by server and the computation algorithms and set of rules may be stored in the server.

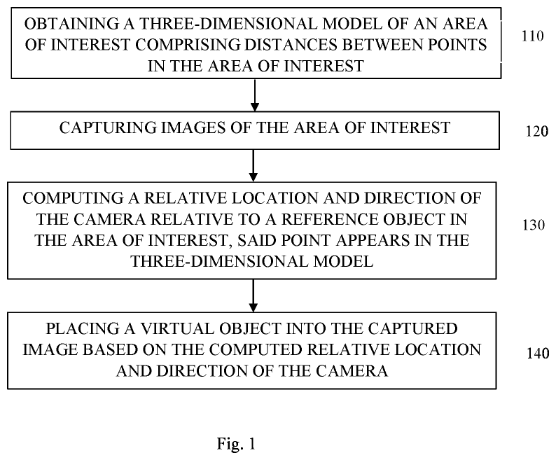

FIG. 1 shows a method for computing a camera's distance and direction relative to a reference object with a setup phase, according to exemplary embodiments of the present invention.

Step 110 discloses obtaining a three-dimensional model (3D model) of an area of interest comprising distances between points in the area of interest. The 3D model may be stored on a personal electronic device in which the camera used to capture the image of the area of interest is embedded. In some other cases, the 3D model may be stored on a dedicated web server, such as an online storage service, or any other URL. In a preferred embodiment of the subject matter, the 3D model is included in a Geographic Information System (GIS).

The 3D model may include a predefined area. In some cases, the 3D model comprises points in a predefined radius surrounding the personal electronic device, for example 400 meters around the personal electronic device. In some cases, a user of the personal electronic device may define the area of interest using a Graphic User Interface (GUI), for example using a touch-operated application. In some cases, the personal electronic device may be communicatively coupled to the web server in which the 3D model is stored. Thus, in response to the GUI receiving the user's request, the web server sends a part of the 3D model to the personal electronic device. In some other cases, the server may receive the captured images and return the device's relative location and direction.

The 3D model comprises a list of points, and distances between the points. The points may be defined by their absolute locations, such as GPS-based locations. The 3D model comprises distances between the points in the area of interest. For example, the distance may be between a first point defined as a leftmost and top most point in a specific building and a first point defined as a rightmost and top most point in the specific building.

Step 120 discloses capturing images of the area of interest. The images may be still images, part of a video stream, and a combination of both. The camera may move while capturing images of the area of interest. The images may be RGB or grayscale. The image may be processed before used to compute the location and direction of the camera relative to the reference object. Such processing may include filtering at least a portion of image, compressing the image and the like.

Step 130 discloses computing a relative location and direction of the camera relative to a predefined point in the area of interest, said point appears in the three-dimensional model. The computation may be performed on the device that captured the image, on site, or on another device, such as an online server with better computation resources. The input of the process of computing a relative location and direction of the camera is the captured image and the 3D model. The 3D model comprises information that enables extracting the distances between points in the area of interest. For example, GPS coordinates of the points in the area of interest, height of the points in the area of interest, and distances measured between objects in the area of interest.

The process of computing a relative location and direction of the camera may comprise estimating distances between points in the captured image according to the distances in the 3D model. That is, in case the distance between points in the captured image is 7.5 pixels in the X direction, this information is compared to the actual distance between the points as extracted from the 3D model. The process comprises multiple associations of pixels or information from the captured image and information extracted from the 3D model. Hence, in many cases, the method comprises identifying the points from the captured image that are included in the 3D model.

The output of the process of computing a relative location and direction of the camera may be defined as an array of 6 values, three values indicating a location of the camera in three axes relative to a predefined reference object in the area of interest, and three values indicating a direction of view of the camera in three axes relative to a predefined reference object. The output may be represented in angles, centimeters and the like. The output may be represented in other methods desired by a person skilled in the art.

Step 140 discloses placing a virtual object into the captured image based on the computed relative location and direction of the camera. The image having the virtual object may be defined as an image containing an augmented reality (AR) object. The virtual object comprises object information that enables to display the object from multiple directions. The object information may include the virtual object's structure, shape, perspectives between height, width and length, and the like. The device that performs the processes disclosed in FIG. 1 receives the output of the process of computing a relative location and direction of the camera and reformats the virtual object according to the computed location and direction. For example, the size of the virtual object in the AR image depends on the relative distance between the camera and the reference object. For example, the higher the distance, the smaller the virtual object appears in the AR image.

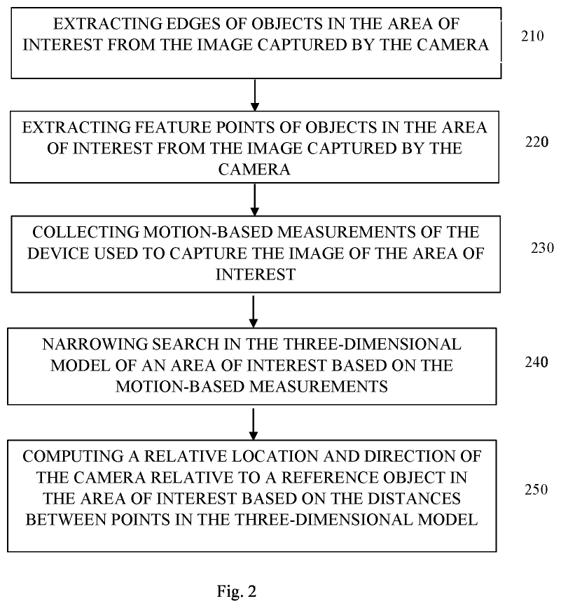

FIG. 2 shows a method for computing a camera's distance and direction relative to a reference object after capturing an image of the area of interest, according to exemplary embodiments of the present invention.

Step 210 discloses extracting edges of objects in the area of interest from the image captured by the camera. The edges may be identified based on changes between pixels' characteristics, such as color, brightness and the like. Other methods for extracting edges may be selected by a person skilled in the art. The edges of objects may be buildings' corners, treetops, pavement corners, and the like. The processing module used to extract the edges may use a set of rules and/or algorithms stored in a memory address accessible to the processing module, either in a personal electronic device or an online storage address (based on a URL known to the processing module). The edges and the location of the edges on the captured image are then stored in a memory address allocated for the edges.

Step 220 discloses extracting feature points of objects in the area of interest from the image captured by the camera. The features may be predefined, such as furniture, persons and the like. The processing module may utilize a bank of images or features' properties to identify the features in the image captured by the camera.

Step 230 discloses collecting motion-based measurements of the device used to capture the image of the area of interest. The motion-based measurements may be collected from a sensor module of the personal electronic device used to capture the images. The sensor module may comprise at least one of the following sensors—gyroscope, accelerometer and magnetometer. The motion-based measurements, combined with the time stamp of capturing the image, provides an indication of the personal electronic device posture when capturing the image. For example, the collected motion-based measurements may show change in the personal electronic device's movement in a specific direction.

Step 240 discloses narrowing search in the three-dimensional model of an area of interest based on the motion-based measurements. For example, in case the sensors indicate that the camera points upwards at 40-50 degrees, and the user moved the personal electronic device clockwise in the X axis prior to capturing the image, it's likely that the camera's direction will be from right to left. The collected motion-based measurements may be used to change the probability assigned to different optional locations of the system as computed in step 250. For example, in case there are three optional locations of the camera relative to the reference object, the collected motion-based measurements may indicate that one of the optional locations has a very low probability.

Step 250 discloses computing a relative location and direction of the camera relative to a reference object in the area of interest based on the distances between points in the three-dimensional model. This step is equivalent to step 130 of FIG. 1. The features and edges extracted from the captured images are compared to the 3D model. In some cases, the distances between the extracted edges and features in the captured image, for example distance in pixels, are compared to distance in the 3D model. That is, the distance between two edges as measured in pixels may change according to the distance between camera and the two edges. The distance in pixels may also change according to the camera's direction relative to the edges. Therefore, in many cases, the processing module utilizes the physical distances of multiple pairs of points as provided by the 3D model, and compares the physical distances to the distances extracted from the captured image. In some cases, the process involves capturing a plurality of images and extracting information from the plurality of images.

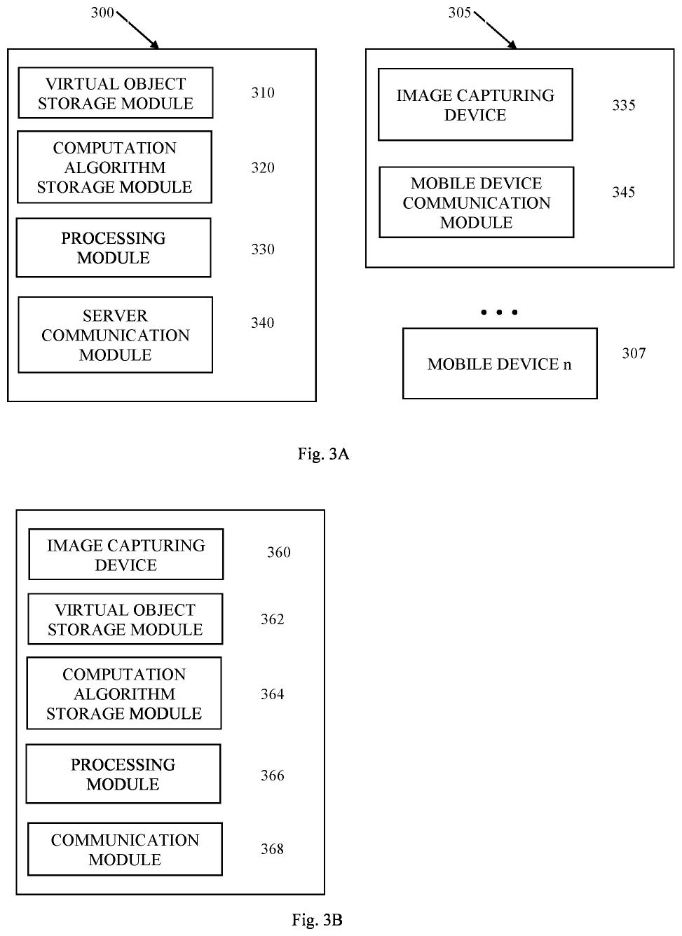

FIGS. 3A-3B show optional systems for computing a camera's distance and direction relative to a reference object, according to exemplary embodiments of the present invention. FIG. 3A shows an optional embodiment, in which a server is used to compute the camera's relative location and direction relative to a reference object in the area of interest, and the server communicates with a device used to capture the image of the area of interest. In FIG. 3B, all the process is performed in the device used to capture the image of the area of interest.

FIG. 3A shows a mobile electronic device 305 communicatively coupled to a remote device 300, such as a server. The mobile electronic device 305 comprises an image capturing device 335 and a mobile device communication module 345. The image capturing device 335 is configured to capture images, such as still image, video stream, IR images, and the like. The image capturing device 335 may be a camera, an image sensor, a surveillance camera, a video camera. The mobile device communication module 345 may have an internet gateway and a processing unit for fetching the captured image from a memory address of the mobile electronic device 305 and send the captured image to the remote device 300. The mobile device communication module 345 may comprise a router, a modem, an antenna, an internet gateway and any other mechanism used to transfer the captured images to the remote device 300 on a wireless manner. The mobile electronic device 305 may be a smartphone, a laptop, a tablet computer and the like.

The remote device 300 may be a server or another computer having dedicated capabilities for the process of the subject matter. The remote device 300 may use online computational resources. The remote device 300 may communicate with multiple mobile electronic device requesting the remote device 300 to perform computations that output the relative position and direction of the camera. Hence, the remote device 300 may also communicate with mobile electronic device 307 operating in the same area of interest as mobile electronic device 305 or in another area of interest.

The remote device 300 comprises a virtual object storage module 310 for storing information related to the virtual object. The information related to the virtual object enables the processing module 330 to place the virtual object in the image according to the relative location and direction of the camera. The information related to the virtual object may include the object's size, form, colors, perspectives and length ratios between pairs of edges in the object's structure, and the like. The virtual object storage module 310 may be assigned memory addresses in the remote device's memory unit. The virtual object storage module 310 may store information related to multiple virtual objects. A user of the remote device may load virtual objects' information into the virtual object storage module 310.

The remote device 300 comprises computation algorithm storage module 320 configured to store the algorithms used to compute the relative location and direction of the camera relative to a reference object. The computation algorithm storage module 320 may store multiple optional algorithms and one or more algorithms are selected according to predefined properties, such as properties of the captured image, properties of the area of interest, properties of the user associated with the device used to capture the image, physical properties of the area of interest such as terrain type, buildings' standard height and the like. The computation algorithm storage module 320 may be assigned memory addresses in the remote device's memory unit.

The remote device 300 comprises processing module 330 for managing the process of computing the relative location and direction of the camera relative to a reference object. The processing module 330 may be a processor or controller operating on a computerized device such as a personal computer, server, virtual machine, cellular phone, tablet computer and the like. The processing module 330 verifies that the server communication module 340 receives the image or images captured by the mobile electronic device 305, and executes a set of rules for computing the relative location and direction of the camera using an algorithm stored in the computation algorithm storage module 320. The processing module 330 may output the camera's location and direction to the server communication module 340 that sends them to the mobile electronic device 305. In some other cases, the output of the camera's location and direction are sent to the virtual object storage module 310 that reformats the virtual object based on the outputted direction and location. The reformatted virtual object may then be sent to the mobile electronic device 305.

The remote device 300 comprises server communication module 340 used to exchange information with other devices. For example, the server communication module 340 may exchange signals with the mobile electronic device 305 used to capture the image of the area of interest. The server communication module 340 may communicate with a device holding a database of 3D models, requesting information concerning the area of interest. The remote device 300 may receive the location of the mobile electronic device 305 and generate a request to the device holding a database of 3D models based on the location of the mobile electronic device 305, for example receive the 3D model in the radius of 300 meters from the location of capturing the image.

FIG. 3B shows an exemplary embodiment in which the computation is performed locally in the mobile electronic device that captured the image of the area of interest. In such embodiment, the mobile electronic device comprises an image capturing device 360 which is equivalent to element 335 disclosed above. The mobile electronic device comprises virtual object storage module 362 which is equivalent to element 310 disclosed above. The mobile electronic device comprises computation algorithm storage module 364 which is equivalent to element 320 disclosed above. The mobile electronic device comprises processing module 366 which is equivalent to element 330 disclosed above. The mobile electronic device comprises server communication module 368 which is equivalent to element 340 disclosed above.

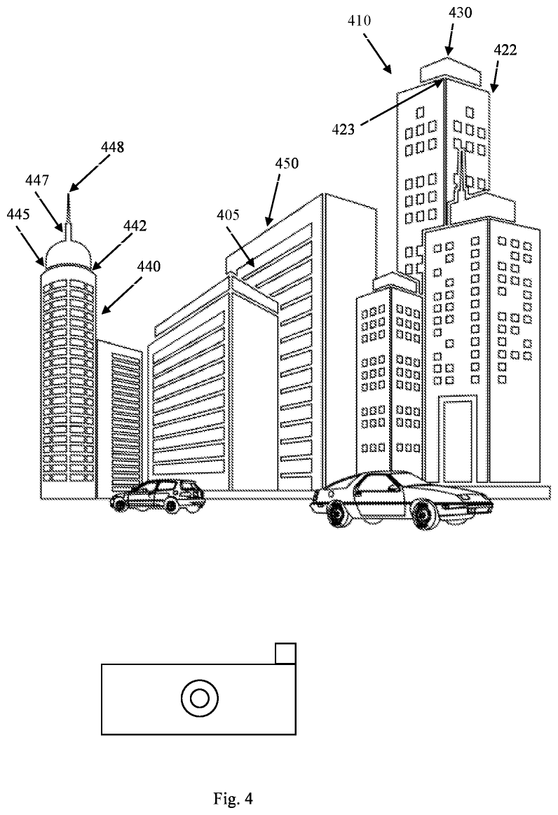

FIG. 4 schematically shows an area of interest captured by the camera, according to exemplary embodiments of the present invention. The area of interest may be urban, having multiple buildings. For example, dome building 440 comprises a main area having two dome top edges 442 and 445. The dome building 440 also comprises top 448 and dome top 447. The dome top 447, top 448 and dome top edges 442 and 445 may be extracted from the image and defined as edges extracted as disclosed in step 210. The roof line 450 of center building 405 may also be extracted by the processing module that processes the captured images of the area of interest. The roof line 450 may be identified as an edge in the captured image showing the area of interest, and the direction of angle in the captured image may be used to compute the camera's direction relative to a reference object in the area of interest. The reference object may be an object which is relatively identifiable by object recognition algorithms. For example, the reference object may be right front corner 423 or right rear corner 422 of rear building 410. Roof line 430 of the rear building 410 may also be used as a feature, similar to the roof line 450 of the center building 405.

The 3D model shows information concerning predefined points in the area of interest. For example, the 3D model may comprise GPS coordinates of the right front corner 423 and the right rear corner 422 of rear building 410. The 3D model may also comprise a physical distance in meters between the right front corner 423 and the right rear corner 422 of rear building 410. The 3D model may also comprise the height difference between at least some of the dome top 447, top 448 and dome top edges 442 and 445. The physical distances of the 3D model and/or coordinates may be used in conjunction with the images of the area of interest.

In some exemplary cases, the method comprises matching between two-dimensional (2D) points in the image captured by the camera to three-dimensional (3D) points in the 3D model. Given a set of points in a 3D space, denoted by (x, y, z), it is desired to match at least a portion of the set of points in a 3D space to corresponding points in the image plane, denoted by (x′, y′).

Such match may be performed manually, by a person selecting which 3D points should be considered in the 3D space. The selection of the points from the 3D model may be performed automatically, based on a predefined set of rules. In some cases, all 3D points are used. In some cases, the method comprises modifying the data stored by each point. For example: the method comprises adding color data or geometric shape for each point.

Detecting the 2D points in the image plane may be performed using different computer vision techniques, like speeded up robust features (SURF), scale-invariant feature transform (SIFT) and/or other known computer vision algorithms for feature detection.

The matching between the image plane points to the points of the 3D model may be performed using computer vision algorithms desired by a person skilled in the art. The method may comprise a process of removing outliers from the optional points in the 3D model, for example using an algorithm such as RANSAC, which is good for dealing with outliers which may be outputted in the process of matching the points in the 3D model and the points in the captured image. For example, in case the matching process found a match between 5 points in the 3D model and 5 points in the captured image and only 3 pairs of points of the 5 pairs are a correct match, the RANSAC algorithm, or an equivalent thereof, will identify that the 2 pairs of points that are an incorrect match do not match with the same solution that defines the relative distance between the camera and the point in the area of interest in all three dimensions. The method may include bundle adjustment methods. For example, given a set of images depicting a number of 3D points from different viewpoints, bundle adjustment can be defined as the problem of simultaneously refining the 3D coordinates describing the scene geometry, the parameters of the relative motion, and the optical characteristics of the camera(s) employed to acquire the images, according to an optimality criterion involving the corresponding image projections of all points.

After obtaining a set of paired points (one point of the pair is extracted from the captured image and another point of the pair is included in the 3D model), the method may use computerized methods for identifying lines and planes in the captured image. Identifying the lines and planes may be performed using an algorithm running on the camera, or using the pinhole camera model and projective geometry. The lines and planes enable to generate a cost function which can be minimized in order to get the most likely camera's position and orientation. The points, one extracted from the captured image and the other included in the 3D model may be defined by distances in three dimensions from a certain point in the area of interest.

In some exemplary cases, the method comprises a step of smoothing the results, in order to avoid irrational “jumps”, which are higher than a predefined threshold. The smoothing may use readings from the kinetic sensors of the device comprising the camera and use a filter and/or other probability distribution algorithms.

At least a portion of the methods disclosed above may be performed using a neural network that was trained to calculate the 6DOF using the device's kinetic sensors and 2D-3D matching pairs.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method for localizing a camera in an area, said method comprising:
obtaining a three-dimensional model of an area of interest comprising distances between points in the area of interest;
capturing images of the area of interest;
matching between two-dimensional (2D) points in the image captured by the camera to three-dimensional (3D) points in the 3D model;
computing a relative location of the camera relative to a reference object based on the three-dimensional model based on said matching;
computing a relative direction of the camera relative to a reference object based on the three-dimensional model based on said matching.

2. The method of claim 1, wherein the method is performed on a personal electronic device comprising a camera used to the capturing images of the area of interest.

3. The method of claim 1, further comprising extracting edges of objects in the area of interest from the image captured by the camera and performing extrapolation between the extracted edges and the three-dimensional model.

4. The method of claim 1, further comprising collecting motion-based measurements of the device used to capture the image of the area of interest.

5. The method of claim 5, further comprising narrowing search in the three-dimensional model of an area of interest based of the motion-based measurements.

6. The method of claim 1, wherein the 3D model comprises a list of points, and distances between the points in the area of interest, wherein the points are defined by their absolute locations, wherein computing the relative location and direction of the camera relative to the predefined point in the area of interest based on the distances between points in the three-dimensional model.

7. The method of claim 1, further comprising generating a cost function which can be minimized in order to get the most likely camera's position and orientation.

8. The method of claim 1, wherein the relative location and direction are defined in 6 values, wherein 3 values define the relative location in each dimension and 3 values define the relative direction in each dimension.

9. The method of claim 1, wherein the 3D model is included in a Geographic Information System (GIS).

10. The method of claim 1, further comprising placing a virtual object into the captured image based on the computed relative location and direction of the camera.

11. The method of claim 12, wherein the virtual object comprises object information that enables to display the object from multiple directions.

12. The method of claim 12, further comprising reformatting the virtual object according to the computed location and direction.
